(19) United States
(12) Patent Application Publication
(10) Pub. No.: US 2026/0154537 A1
(43) Pub. Date: Jun. 4, 2026

(54) SPIKE NEURAL NETWORK CIRCUIT

(71) Applicant: ELECTRONICS AND TELECOMMUNICATIONS RESEARCH INSTITUTE, Daejeon (KR)

(72) Inventors: Kwang IL OH, Daejeon (KR); Byung-Do YANG, Daejeon (KR); Min-Woo KIM, Cheongju-si (KR); Jae-Jin LEE, Daejeon (KR)

(21) Appl. No.: 19/377,601

(22) Filed: Nov. 3, 2025

(30) Foreign Application Priority Data
Dec. 2, 2024 (KR) 10-2024-0176831

(51) Int. Cl. G06N 3/049; G06N 3/065

(52) U.S. Cl. CPC G06N 3/049; G06N 3/065

(57) ABSTRACT

A spike neural network circuit is disclosed. The SNN circuit includes a first synapse and a second synapse connected to a first column line and configured to adjust a charge level of the first column line based on a first synapse weight value and a second synapse weight value, respectively, in response to a first input spike signal and a second input spike signal. A first shared bias current source provides a bias current used by the first and second synapses for the charge adjustment. A first neuron compares a voltage level of the first column line with a reference voltage and generates an output spike signal in response to the comparison.

### CROSS-REFERENCE TO RELATED APPLICATIONS

This application claims priority under 35 U.S.C. § 119 to Korean Patent Application No. 10-2024-0176831 filed on December 2, 2024 in the Korean Intellectual Property Office, the disclosures of which are incorporated by reference herein in their entireties.

### BACKGROUND

### 1. Field of the Invention

The present disclosure relates to a neural network, and more particularly, to a spike neural network circuit.

### 2. Description of Related Art

A spike neural network (SNN) is one type of artificial intelligence network implementation method that outputs a series of results based on network operations in response to inputs applied to the network. Unlike conventional perceptron-based networks or convolution-based networks, which transmit input signals as numerical values of a certain magnitude, the spike neural network transmits signals in the form of pulses having a very short time width, and performs operations based on such signals. Specifically, when spike trains (e.g., intermittent, aperiodic, or periodic) are applied as inputs (axons) to the network, certain nodes perform network operations corresponding to the inputs. The spikes are transmitted along predetermined spike transmission paths to subsequent nodes or subsequent spike neural networks.

As elements for performing network operations in response to spike inputs, synapses and neurons are provided. A synapse responds to a spike applied from the input by applying a synapse weight to the corresponding node and delivering the result to a neuron. A neuron may be connected to a plurality of synapses, and each processing result is provided as input to the same neuron.

The neuron accumulates the results of respective synapse operations to form a membrane potential, and fires when the accumulated potential exceeds a reference voltage. The neuron outputs a spike upon firing.

The spike neural network circuit may be implemented as a semiconductor circuit. Each synapse may include a current source configured to perform an analog charge operation corresponding to a synapse weight. However, leakage current generated at the gate terminals of transistors included in the current sources of the synapses may increase the error of operations performed by the synapses.

### SUMMARY

An object of the present disclosure is to provide a spike neural network circuit capable of minimizing error when performing analog charge operations.

According to an embodiment of the present disclosure, a spike neural network circuit may include a first synapse connected to a first column line among a plurality of column lines and configured to adjust a charge level of the first column line according to a first synapse weight value in response to a first input spike signal applied to a first row line among a plurality of row linessynapse, a second synapse connected to the first column line and configured to adjust the charge level of the first column line according to a second synapse weight value in response to a second input spike signal applied to a second row line among the plurality of row linessynapse, a first shared bias current source configured to provide a bias current used when each of the first and second synapses adjusts the charge level of the first column line, and a first neuron configured to compare a voltage level of the first column line with a reference voltage, and to generate a first output spike signal in response to the voltage level of the first column line reaching the reference voltage.

According to another embodiment of the present disclosure, the spike neural network circuit may comprises a synapse circuit including a plurality of row lines, a plurality of column lines, and a plurality of synapses connected to the plurality of row lines and the plurality of column lines, a neuron circuit including neurons configured to compare a voltage level of corresponding one of the plurality of column lines with a reference voltage and to generate an output spike signal when the voltages level of the corresponding column lines reaching the reference voltage, an address decoder configured to receive an input address and a spike input in a pulse form, and to output an input spike signal to a row line corresponding to the input address among the plurality of row lines in response to the spike input, and an address encoder configured to output an output address corresponding to a column line anong the plurality of column lines from which the output spike signal is generated and to output a spike output in a pulse form in response to the output spike signal. The synapse circuit may further include a shared bias current source configured to provide a bias current used when each of the first and second synapses corresponding to the first column line adjusts the charge level of the first column line.

### BRIEF DESCRIPTION OF THE DRAWINGS

The above and other objects and features of the present disclosure will become apparent by describing in detail embodiments thereof with reference to the accompanying drawings.

FIG. 1 is a block diagram illustrating a spike neural network circuit according to an embodiment of the present disclosure.

FIG. 2 is a timing diagram illustrating an operation of the spike neural network circuit according to an embodiment of the present disclosure.

FIG. 3 is a diagram illustrating a portion of the spike neural network circuit according to an embodiment of the present disclosure.

FIG. 4 is a diagram illustrating an example of a synapse according to an embodiment of the present disclosure.

FIG. 5A is a diagram illustrating a weight switch according to an embodiment of the present disclosure.

FIG. 5B is a diagram illustrating a shared bias current source according to an embodiment of the present disclosure.

FIG. 6 is a diagram illustrating an example of a synapse circuit according to an embodiment of the present disclosure.

FIGS. 7A and 7B are diagrams illustrating a charge subtraction operation of the synapse circuit according to an embodiment of the present disclosure.

FIG. 8 is a diagram illustrating an operation of an address decoder according to an embodiment of the present disclosure.

FIG. 9 is a diagram illustrating an example of a spike neural network circuit according to an embodiment of the present disclosure.

FIG. 10 is a diagram illustrating an example of a structure of an address decoder according to an embodiment of the present disclosure.

### DETAILED DESCRIPTION

Hereinafter, embodiments of the present disclosure will be clearly and elaborately described to the extent that a person skilled in the art to which the present disclosure pertains can easily carry out the present disclosure.

In the detailed description, components described with reference to terms such as “unit,” “module,” “block,” “-or,” or “-er,” as well as functional blocks illustrated in the drawings, may be implemented in the form of software, hardware, or a combination thereof. By way of example, the software may include machine code, firmware, embedded code, and application software. The hardware may include, for example, electrical circuits, electronic circuits, processors, computers, integrated circuits, integrated circuit cores, pressure sensors, inertial sensors, microelectromechanical systems (MEMS), passive elements, or combinations thereof.

In this document, each of phrases such as "A or B", "at least one of A and B", "at least one of A or B", "A, B or C", "at least one of A, B and C", and "at least one of A, B, or C" may include any one of the items listed together in the corresponding phrase or all possible combinations thereof.

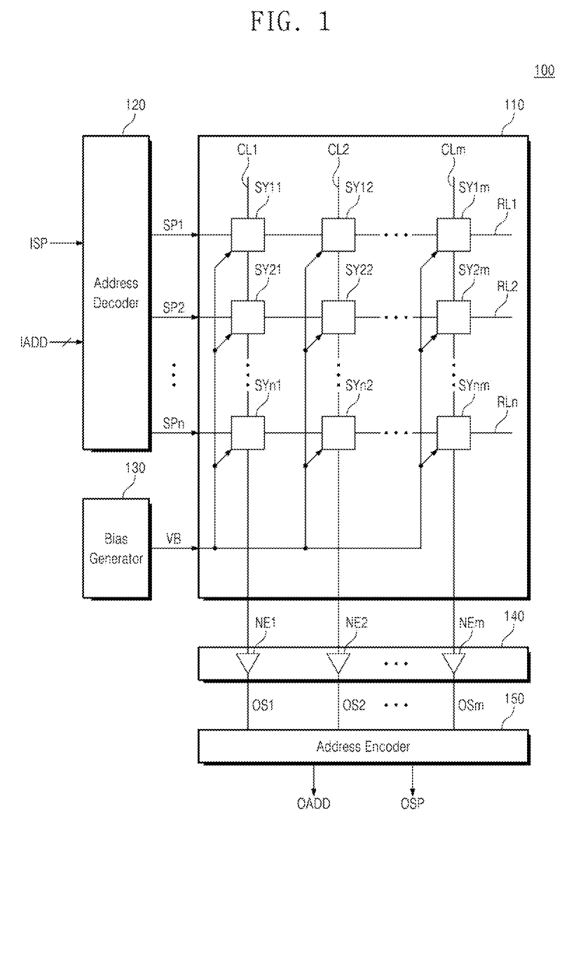

FIG. 1 is a block diagram illustrating a spike neural network circuit according to an embodiment of the present disclosure.

Referring to FIG. 1, a spike neural network circuit 100 may include a synapse circuit 110, an address decoder 120, a bias current generator 130, a neuron circuit 140, and an address encoder 150.

The synapse circuit 110 may include a plurality of row lines RL1, RL2, …, RLn corresponding to respective rows, a plurality of column lines CL1, CL2, …, CLm corresponding to respective columns, and a plurality of synapses SY11, SY12, …, SYnm arranged in rows and columns. The synapses SY11–SYnm may be connected to the row lines RL1–RLn and the column lines CL1–CLm. For example, the synapse SY11 may be connected to the row line RL1 and the column line CL1, the synapse SY12 may be connected to the row line RL1 and the column line CL2, and the synapse SYnm may be connected to the row line RLn and the column line CLm. The row lines RL1–RLn may correspond to axons of the spike neural network circuit 100, and the column lines CL1–CLm may correspond to membranes. The synapses SY11–SYnm may define correlations between axons and neurons. The connection strength between the axons and neurons may be represented by synapse weights of the respective synapses SY11–SYnm. The synapses SY11–SYnm may adjust a charge level of the respective column lines CL1-CLm in response to the corresponding input spike signals SP1–SPn.

The address decoder 120 may receive an input address IADD and a spike input ISP. The spike input ISP may be in the form of a pulse. The address decoder 120 may output an input spike signal to a row line corresponding to the input address IADD among the row lines RL1–RLn. For example, when the input address IADD points to the first row line RL1, the address decoder 120 may output a first input spike signal SP1 to the first row line RL1 in response to the spike input ISP. When the input address IADD points to the second row line RL2, the address decoder 120 may output a second input spike signal SP2 to the second row line RL2 in response to the spike input ISP.

The bias generator 130 generates a bias voltage VB used by the synapses SY11–SYnm. The bias voltage VB may be provided to each of the synapses SY11–SYnm. The synapses SY11–SYnm may use the bias voltage VB when performing analog charge operations.

The neuron circuit 140 my includes neurons NE1, NE2, …, NEm. The neurons NE1–NEm may correspond to the respective columns. For example, a neuron NE1 may correspond to the first column, a neuron NE2 may correspond to the second column, and a neuron NEm may correspond to the m-th column. The neurons NE1–NEm may compare voltages of the respective column lines CL1–CLm with a reference voltage. The neuron NE1 may compare the voltage level of the first column line CL1 with the reference voltage, and the neuron NE2 may compare the voltage level of the second column line CL2 with the reference voltage.

The neuron circuit 140 may output output spike signals OS1, OS2, …, OSm based on results of the voltage comparisons. For example, the neuron NE1 may output a first output spike signal OS1 based on the comparison result, and the neuron NE2 may output a second output spike signal OS2 based on the comparison result of the second column line CL2.

The address encoder 150 may receive the output spike signals OS1–OSm. When receiving each of the output spike signals OS1–OSm, the address encoder 150 may output an output address OADD corresponding to a column line and a spike output OSP. For example, when the address encoder 150 receives a first output spike signal OS1, it may output the output address OADD corresponding to the first column line CL1 and the spike output OSP. When the address encoder 150 receives a second output spike signal OS2, it may output the output address OADD corresponding to the second column line CL2 and the spike output OSP.

The analog charge operation of the spike neural network circuit 100 may be implemented with a semiconductor circuit structure configured to accumulate charge levels of the respective column lines CL1–CLm or to subtract charge level of the respective column lines CL1–CLm. For example, the plurality of synapses SY11–SYnm may subtract the charge levels of the column lines CL1–CLm according to synapse weights in response to the corresponding input spike signals SP1–SPn. The potential of the column lines CL1–CLm may decrease due to the charge subtraction. Alternatively, the plurality of synapses SY11–SYnm may accumulate the charge levels of the column lines CL1–CLm by an amount corresponding to synapse weights in response to the corresponding input spike signals SP1–SPn. The potential of the column lines CL1–CLm may increase due to the charge accumulation.

When the analog charge operation based on a charge accumulation type is applied to the spike neural network circuit 100, the neuron circuit 140 may generate an output spike signal when the voltage level of respective column lines CL1, CL2, …, CLm exceeds a reference voltage, and reset the voltage level of respective column lines CL1, CL2, …, CLm to a first initialization voltage. When the analog charge operation based on a charge subtraction type is applied to the spike neural network circuit 100, the neuron circuit 140 may generate an output spike signal when the voltage level of respective column lines CL1, CL2, …, CLm is lower than the reference voltage, and reset the voltage of respective column lines CL1, CL2, …, CLm to a second initialization voltage.

For convenience of explanation, the following description considers the analog charge operation based on the charge subtraction type. However, it will be appreciated by those skilled in the art that the analog charge operation of the charge accumulation type may also be applied.

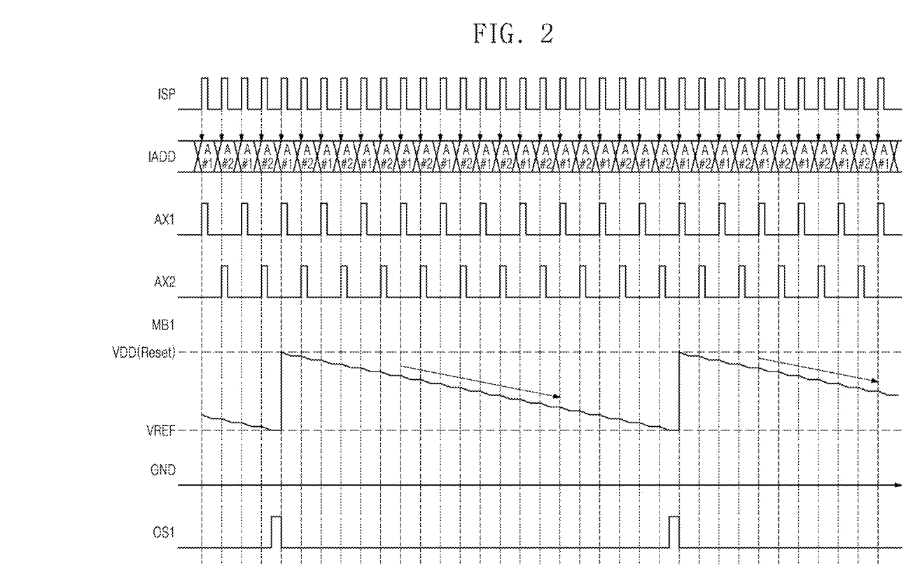

FIG. 2 is a timing diagram illustrating an operation of a spike neural network circuit according to an embodiment of the present disclosure.

Referring to FIG. 2, a spike input ISP may be distributed to axons AX1 and AX2 based on an input address IADD. For example, when the input address IADD indicates A#1 corresponding to a first axon AX1, the address decoder 120 may decode the input address IADD and output a first input spike signal to the first axon AX1. The first input spike signal may be delivered to the first row line corresponding to the first axon AX1.

When the input address IADD indicates A#2 corresponding to a second axon AX2, the address decoder 120 may decode the input address IADD and output a second input spike signal to the second axon AX2. The second input spike signal may be delivered to the second row line corresponding to the second axon AX2.

A first synapse connecting the first axon AX1 and a first membrane MB1 may subtract a charge level of the first membrane MB1 in response to the first input spike signal. In this case, the subtracted charge amount may correspond to a synapse weight value of the first synapse. A second synapse connecting the second axon AX2 and the first membrane MB1 may subtract the charge level of the first membrane MB1 in response to the second input spike signal. In this case, the subtracted charge amount may correspond to a synapse weight value of the second synapse. As the charge level of the first membrane MB1 is subtracted, the voltage level of the first membrane MB1 may decrease.

When the voltage level of the first membrane MB1 decreases below a reference voltage VREF, a first neuron NE1 corresponding to the first membrane MB1 may fire. In response to the firing of the first neuron NE1, a first output spike signal OS1 may be generated. The voltage level of the first membrane MB1 may then be reset to a power supply voltage VDD corresponding to an initialization voltage.

The generation of the output spike signal may be determined by factors such as the synapse weight values of the respective synapses, the frequency of the input spike signals, and the reference voltage.

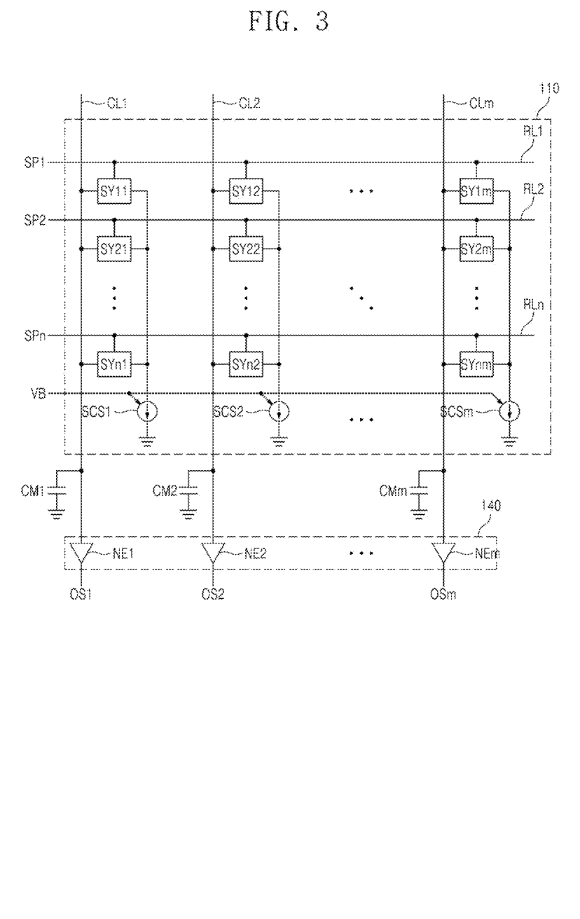

FIG. 3 is a diagram illustrating a portion of the spike neural network circuit according to an embodiment of the present disclosure.

Referring to FIG. 3, the spike neural network circuit 100 may further include membrane capacitors CM1, CM2, …, CMm corresponding to respective column lines CL1–CLm. The membrane capacitors CM1–CMm may store charges of the corresponding column lines CL1–CLm.

The synapses SY11–SYnm may include current mode digital-to-analog converters (DACs). The synapses SY11–SYnm may perform analog charge operations based on synapse weight values represented in digital form. For example, the synapses SY11, SY21, …, SYn1 may subtract a charge level of the membrane capacitor CM1 by an amount corresponding to digital synapse weight values. The synapses SY12, SY22, …, SYn2 may subtract a charge level of the membrane capacitor CM2 by an amount corresponding to digital synapse weight values.

The synapse circuit 110 may include shared bias current sources SCS1, SCS2, …, SCSm corresponding to the respective column lines CL1–CLm. The shared bias current sources SCS1–SCSm may provide bias currents used when the synapses SY11–SYnm subtract charge levels of the corresponding column lines CL1–CLm. The voltages of the column lines CL1–CLm may be maintained by the charges stored in the membrane capacitors CM1–CMm. The shared bias current sources SCS1–SCSm may provide bias currents based on a bias voltage VB.

For example, the first shared bias current source SCS1 may provide a bias current used when the synapses SY11, SY21, …, SYn1 subtract charge levels of the first column line CL1. The second shared bias current source SCS2 may provide a bias current used when the synapses SY12, SY22, …, SYn2 subtract charge levels of the second column line CL2.

The synapses SY11, SY12, …, SY1m may subtract charge levels of corresponding column lines CL1, CL2, …, CLm in response to a first input spike signal SP1.

The neurons NE1, NE2, …, NEm included in the neuron circuit 140 may compare voltage levels of the column lines CL1–CLm with a reference voltage and output output spike signals OS1–OSm based on comparison results.

When each of the synapses SY11–SYnm is provided with a separate bias current source, a bias voltage may be applied to gate terminals of transistors of the bias current sources based on a current mirror method. In this case, as the scale of the spike neural network circuit 100 increases, leakage currents to the gate terminals of the transistors may also increase, thereby causing errors in the analog charge operations accumulated in the column lines CL1–CLm.

By sharing the shared bias current sources SCS1–SCSm, the synapses SY11–SYnm do not need to be individually provided with separate bias current sources, and leakage currents of the column lines CL1–CLm may be minimized. In addition, by sharing the shared bias current sources SCS1–SCSm, the area of the spike neural network circuit 100 may be reduced.

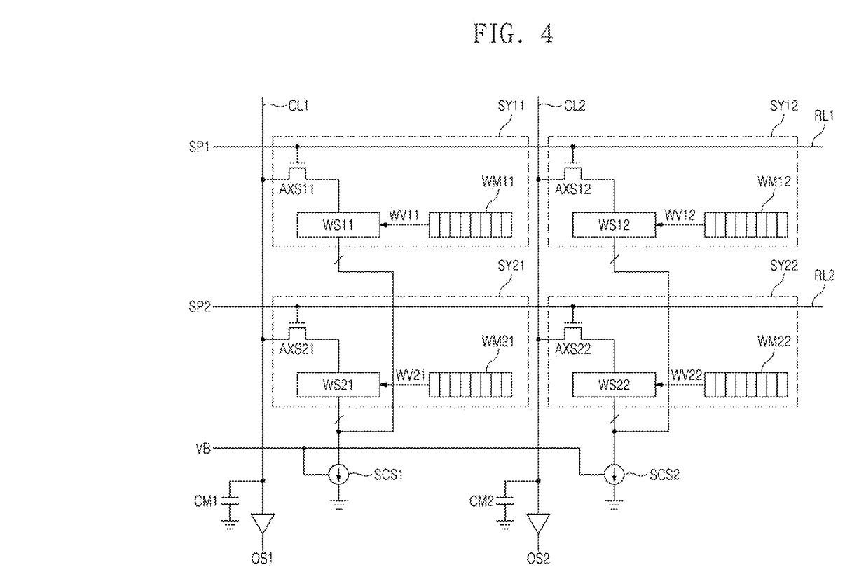

FIG. 4 is a diagram illustrating an example of a synapse according to an embodiment of the present disclosure.

Referring to FIG. 4, a synapse SY11 may include a weight switch WS11, a weight switch WS21, and an axon switch AXS11 connecting the weight switches WS11 and WS21 to a first column line CL1.

A synapse SY21 may include a weight switch WS21, a weight switch WS21, and an axon switch AXS21 connecting the weight switches WS21 and WS21 to a second column line CL2.

The weight switch WS11 may receive a synapse weight value WV11 from a weight memory WM11. The synapse weight value WV11 may correspond to a connection strength between an axon and a neuron. That is, the synapse weight value WV11 may correspond to a correlation between the first column line CL1 and the first row line RL1.

The axon switch AXS11 connects the weight switch WS11 to the first column line CL1. The axon switch AX11 may be turned on in response to a first input spike signal SP1. For example, the axon switch AX11 may be turned on according to a first logic level (e.g., high level) of the first input spike signal SP1, and may be turned off according to a second logic level (e.g., low level) of the first input spike signal SP1.

The weight switch WS21 may receive a synapse weight value WV21 from a weight memory WM21. The synapse weight value WV21 may correspond to a connection strength between the second row line RL2 and the first column line CL2. The axon switch AX21 may be turned on in response to a second input spike signal SP2.

The synapse weight values WV11, WV12, WV21, and WV22 may be represented in digital form. For example, each of the synapse weight values WV11–WV22 may be expressed by a plurality of synapse weight bits. For instance, the synapse weight values WV11, WV12, WV21, and WV22 may be expressed as values of 8-bit depth.

The bit depth of the synapse weight values WV11–WV22 is exemplary, and may be variously determined depending on requirements of the spike neural network circuit 100.

The weight switches WS11 and WS21 may be connected to a first shared bias current source SCS1, and the weight switches WS12 and WS22 may be connected to a second shared bias current source SCS2. The first shared bias current source SCS1 and the second shared bias current source SCS2 may each operate based on a bias voltage VB. The first shared bias current source SCS1 may provide a bias current used when the weight switches WS11 and WS21 subtract charge levels of a membrane capacitor CM1 corresponding to the first column. The second shared bias current source SCS2 may provide a bias current used when the weight switches WS12 and WS22 subtract charge levels of a membrane capacitor CM2 corresponding to the second column.

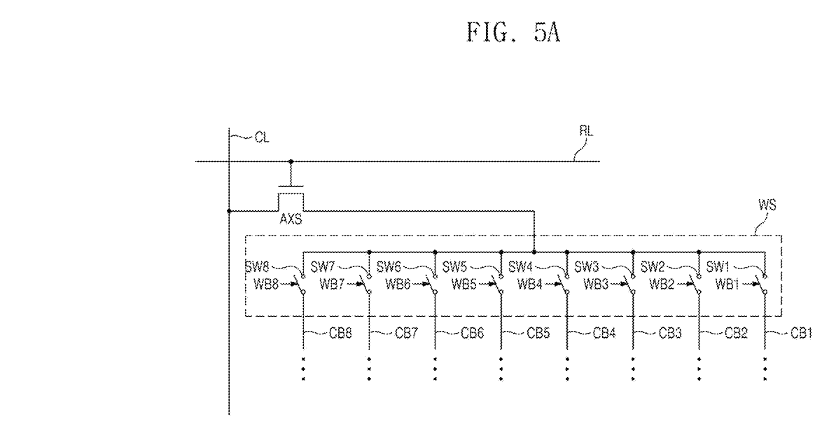

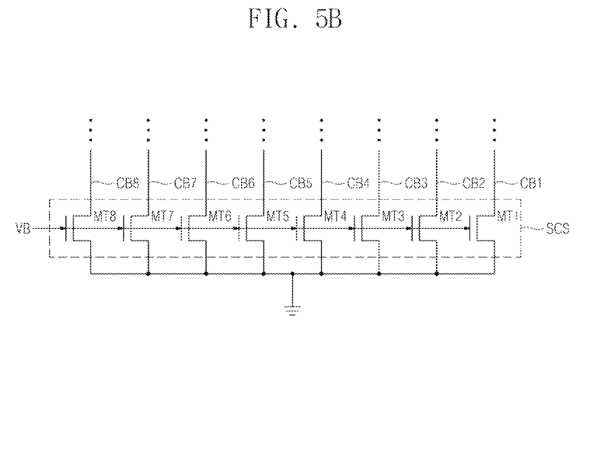

FIG. 5a is a diagram illustrating a weight switch according to an embodiment of the present disclosure. FIG. 5b is a diagram illustrating a shared bias current source according to an embodiment of the present disclosure.

Referring to FIG. 5a, a weight switch WS may include a plurality of switches SW1, SW2, …, SW8 that operate based on respective synapse weight bits WB1, WB2, …, WB8. Each of the plurality of switches SW1–SW8 may correspond to one of a plurality of current branches CB1, CB2, …, CB8.

The plurality of switches SW1–SW8 may be connected in parallel. The plurality of current branches CB1–CB8 may extend from the plurality of switches SW1–SW8.

A synapse weight value may be represented in binary form through the plurality of synapse weight bits WB1–WB8. The plurality of switches SW1–SW8 may operate according to corresponding synapse weight bits WB1–WB8. For example, a first switch SW1 may be turned on when the synapse weight bit WB1 is “1” and turned off when the synapse weight bit WB1 is “0.” Similarly, a second switch SW2 may be turned on when the synapse weight bit WB2 is “1” and turned off when the synapse weight bit WB2 is “0.”

Referring to FIG. 5b, a shared bias current source SCS may operate based on a bias voltage VB and may include a plurality of current source transistors MT1, MT2, …, MT8 corresponding to the plurality of current branches CB1–CB8.

The plurality of current source transistors MT1–MT8 may be MOSFETs (metal-oxide-semiconductor field-effect transistors). Each of the plurality of current source transistors MT1–MT8 may have a different current supply capability. For example, a current source transistor MT1 and a current source transistor MT2 may have different current supply capabilities.

Each of the plurality of current source transistors MT1–MT8 may have a current supply capability that increases in powers of two. For example, the current source transistor MT2 may have twice the current supply capability of the current source transistor MT1, and the current source transistor MT3 may have twice the current supply capability of the current source transistor MT2. The plurality of current source transistors MT1–MT8 may have different sizes in order to provide current supply capabilities that increase in powers of two. For example, an eighth current source transistor MT8 may have a width or length larger than that of a first current source transistor MT1 in order to provide a larger current supply capability.

The first current source transistor MT1 may have a relatively larger width than the eighth current source transistor MT8.

Referring to FIGS. 5a and 5b, a charge level of a column line CL may be subtracted by the weight switch WS and the shared bias current source SCS connected thereto.

When an input spike signal having a first logic level is applied to an axon switch AXS through a row line RL, the axon switch AXS may be turned on. At this time, each of the switches SW1–SW8 may be turned on or off according to values of the synapse weight bits WB1–WB8. The charge level of the column line CL may be subtracted through switches in the on-state, the current branches connected to the on-state switches, and the current source transistors connected to the current branches. When a second logic level is applied to the row line RL, the subtraction of the charge level of the column line CL may be stopped.

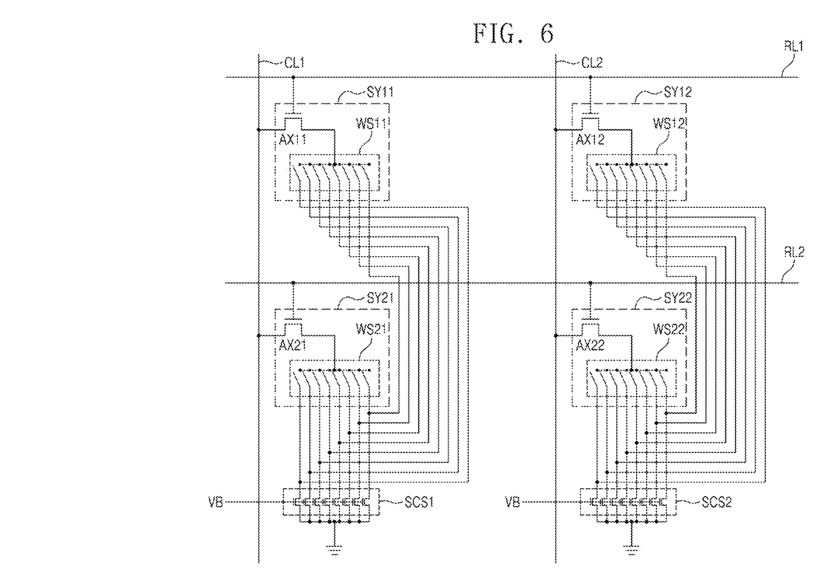

FIG. 6 is a diagram illustrating an example of a synapse circuit according to an embodiment of the present disclosure.

Referring to FIG. 6, each of the synapses SY11–SY22 may include corresponding axon switches AXS11, AXS12, AXS21, and AXS22 and corresponding weight switches WS11–WS22.

The weight switch WS11 and the weight switch WS21 may be connected to a first shared bias current source SCS1. The weight switch WS11 may include a plurality of switches connected in parallel, each branching from respective current branches. The plurality of switches included in the weight switch WS11 may be connected to current source transistors included in the first shared bias current source SCS1. The weight switch WS21 may also include a plurality of switches connected in parallel, each branching from respective current branches. The plurality of switches included in the weight switch WS21 may also be connected to current source transistors included in the first shared bias current source SCS1.

The weight switch WS12 and the weight switch WS22 may be connected to a second shared bias current source SCS2. The weight switch WS12 may include a plurality of switches connected in parallel according to respective current branches. The plurality of switches included in the weight switch WS12 may be connected to current source transistors included in the second shared bias current source SCS2. The weight switch WS22 may also include a plurality of switches connected in parallel according to respective current branches. The plurality of switches included in the weight switch WS22 may likewise be connected to current source transistors included in the second shared bias current source SCS2.

In other words, the current branches of each of the weight switches WS11–WS22 may be grouped by column and connected to the corresponding shared bias current source SCS1 or SCS2.

At this time, the bias current provided by the first shared bias current source SCS1 may be used to subtract a charge level of a membrane capacitor CM1 connected to a first column line CL1, and the bias current provided by the second shared bias current source SCS2 may be used to subtract a charge level of a membrane capacitor CM2 connected to a second column line CL2.

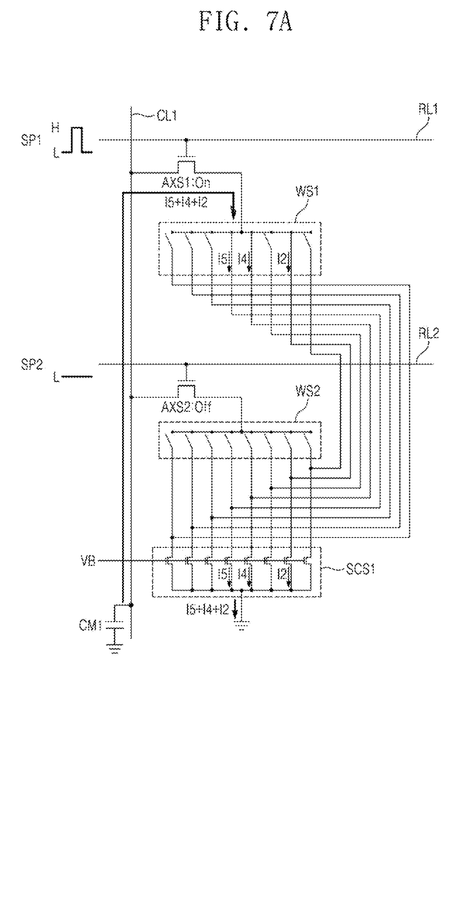

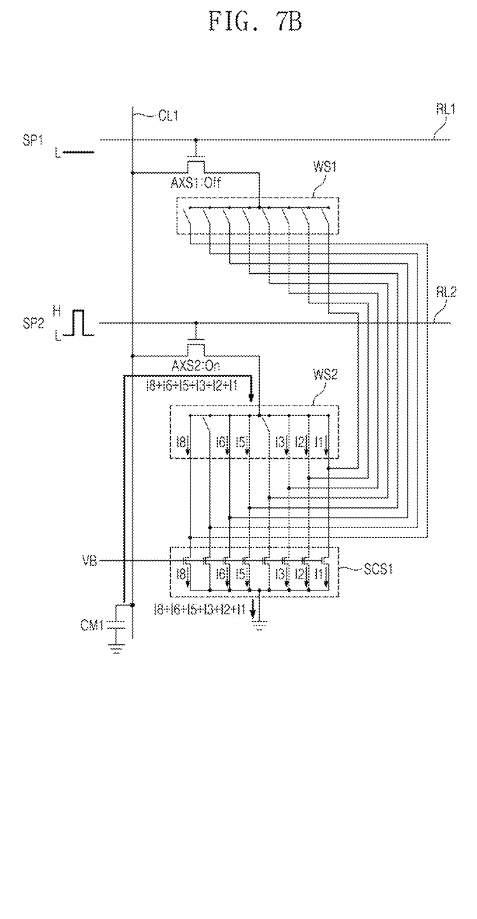

FIGS. 7a and 7b are diagrams illustrating a charge subtraction operation of a synapse circuit according to an embodiment of the present disclosure.

Referring to FIG. 7a, in response to a first input spike signal SP1 being at a first logic level (H), an axon switch AXS1 may be turned on. Each of the plurality of switches included in a first weight switch WS1 may be turned on by corresponding synapse weight bits. Assume that the synapse weight bits have values of <0, 0, 1, 1, 0, 0, 1, 0>. The leftmost synapse weight bit is a most significant bit (MSB) and corresponds to an eighth switch, while the rightmost synapse weight bit is a least significant bit (LSB) and corresponds to a first switch. Among the plurality of switches included in the weight switch WS1, the second switch, the fourth switch, and the fifth switch may be turned on by the synapse weight bits.

The current source transistors included in a shared bias current source SCS1 may operate according to a bias voltage VB. Each current source transistor has a corresponding current supply capability. For example, a second current source transistor corresponding to the second switch may have a current supply capability of I2, a fourth current source transistor corresponding to the fourth switch may have a current supply capability of I4, and a fifth current source transistor corresponding to the fifth switch may have a current supply capability of I5.

Due to an axon switch AXS2 being turned off, charge subtraction by a second weight switch WS2 does not occur.

While the axon switch AXS1 is turned on, the charge level of a membrane capacitor MC1 may be subtracted by an amount corresponding to a current of I5 + I4 + I2, through the operation of the switches turned on and the corresponding current source transistors.

Referring to FIG. 7b, in response to a second input spike signal SP2 being at a first logic level (H), an axon switch AXS2 may be turned on. Each of the plurality of switches included in a second weight switch WS2 may be turned on by corresponding synapse weight bits. Assume that the synapse weight bits have values of <1, 0, 1, 1, 0, 1, 1, 1>. The synapse weight bits may turn on the first, second, third, fifth, sixth, and eighth switches. The current source transistors included in the shared bias current source SCS1 may operate according to the bias voltage VB. While the axon switch AXS2 is turned on, the charge level may be subtracted by an amount corresponding to a current of I8 + I6 + I5 + I3 + I2 + I1, through the operation of the switches turned on and the corresponding current source transistors.

Due to the axon switch AXS1 being turned off, charge subtraction by the first weight switch WS1 does not occur.

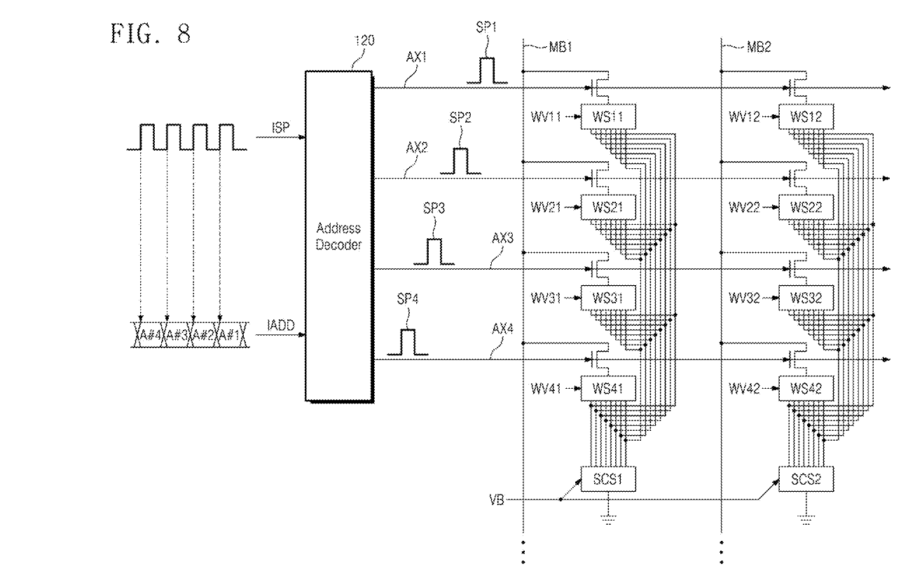

FIG. 8 is a diagram illustrating an operation of an address decoder according to an embodiment of the present disclosure.

Referring to FIG. 8, an address decoder 120 may receive a spike input ISP and an input address IADD. The address decoder 120 may output an input spike signal to an axon corresponding to the input address IADD among a plurality of axons AX1, AX2, …, AX4.

Current branches of weight switches WS11, WS21, WS31, and WS41 corresponding to a first column may be connected to a first shared bias current source SCS1. Current branches of weight switches WS12, WS22, WS32, and WS42 corresponding to a second column may be connected to a second shared bias current source SCS2.

The address decoder 120 may receive an input address IADD A#1 indicating a first axon AX1. In response to the spike input ISP, the address decoder 120 may output a first input spike signal SP1 through the first axon AX1. The weight switch WS11 may, in response to the first input spike signal SP1, subtract a charge level of a first membrane MB1 by an amount corresponding to a synapse weight value. In this case, the charge level of the first membrane MB1 may be subtracted through the weight switch WS11 and the first shared bias current source SCS1. The weight switch WS12 may, in response to the first input spike signal SP1, subtract a charge level of a second membrane MB2 by an amount corresponding to a synapse weight value. In this case, the charge level of the second membrane MB2 may be subtracted through the weight switch WS12 and the second shared bias current source SCS2.

The address decoder 120 may receive an input address IADD A#2 indicating a second axon AX2. In response to the spike input ISP, the address decoder 120 may output a second input spike signal SP2 through the second axon AX2. The weight switch WS21 may, in response to the second input spike signal SP2, subtract a charge level of the first membrane MB1 by an amount corresponding to a synapse weight value. The weight switch WS22 may, in response to the second input spike signal SP2, subtract a charge level of the second membrane MB2 by an amount corresponding to a synapse weight value.

The address decoder 120 may receive input addresses IADD A#3 and A#4 indicating a third axon AX3 and a fourth axon AX4. In response to the spike input ISP, the address decoder 120 may output a third input spike signal SP3 and a fourth input spike signal SP4 through the third axon AX3 and the fourth axon AX4, respectively. The weight switch WS31 may, in response to the third input spike signal SP3, subtract a charge level of the first membrane MB1, and the weight switch WS32 may, in response to the third input spike signal SP3, subtract a charge level of the second membrane MB2. The weight switch WS41 may, in response to the fourth input spike signal SP4, subtract a charge level of the first membrane MB1, and the weight switch WS42 may, in response to the fourth input spike signal SP4, subtract a charge level of the second membrane MB2.

Meanwhile, the plurality of axons AX1, AX2, … may correspond to the plurality of row lines RL1, RL2, …, RLn of FIG. 1. The plurality of membranes MB1, MB2, … may correspond to the plurality of column lines CL1, CL2, …, CLm of FIG. 1.

The address decoder 120 may receive the input address IADD and spike input ISP in a pulse form, and may output input spike signals SP1–SP4 to a row corresponding to the input address IADD. In this case, only one input spike signal may be generated in response to one spike input, thereby preventing input spike signals from being simultaneously generated in multiple rows. This prevents weight switches WS11–WS42 corresponding to the same column from being simultaneously turned on. Each of the shared bias current sources SCS1 and SCS2 may provide a bias current only to a weight switch corresponding to one row. This prevents duplicate generation of input spike signals.

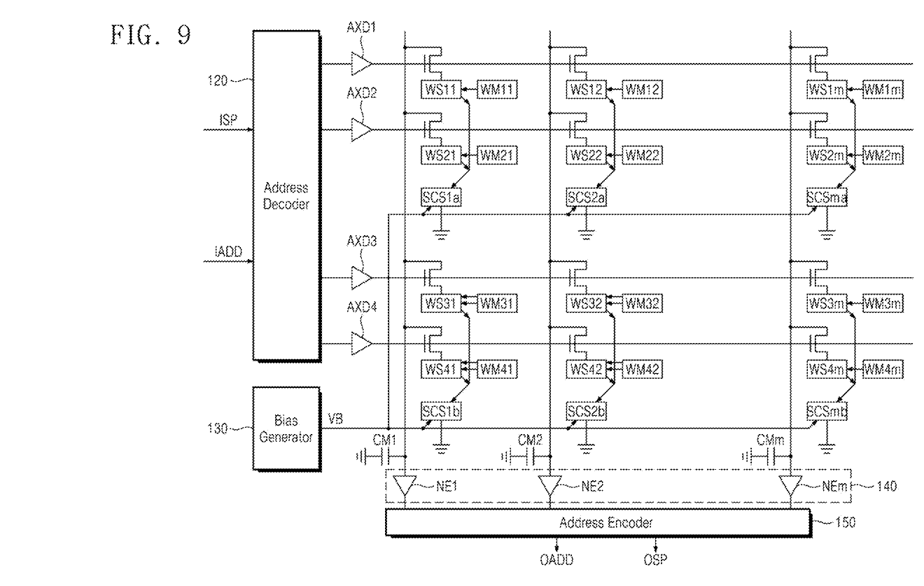

FIG. 9 is a diagram illustrating an example of a spike neural network circuit according to an embodiment of the present disclosure.

Referring to FIG. 9, one column may correspond to one or more shared bias current sources.

A first column may correspond to a shared bias current source SCS1a and a shared bias current source SCS1b. In this case, weight switches WS11 and WS21 corresponding to the first column may be connected to the shared bias current source SCS1a, and weight switches WS31 and WS41 corresponding to the first column may be connected to the shared bias current source SCS1b.

A second column may correspond to a shared bias current source SCS2a and a shared bias current source SCS2b. In this case, weight switches WS21 and WS22 corresponding to the second column may be connected to the shared bias current source SCS2a, and weight switches WS32 and WS42 corresponding to the second column may be connected to the shared bias current source SCS2b.

Meanwhile, the spike neural network circuit 100 may further include axon drivers AXD1, AXD2, …, AXD4. The axon drivers AXD1–AXD4 may amplify an input spike signal and output the amplified signal to a corresponding row.

A bias generator 130 may generate a bias voltage VB applied to the shared bias current sources SCS1a, SCS2a, …, SCSmb.

According to an embodiment of the present disclosure, synapses corresponding to the same column may be grouped into two or more groups, and the synapses of each group may share one shared bias current source.

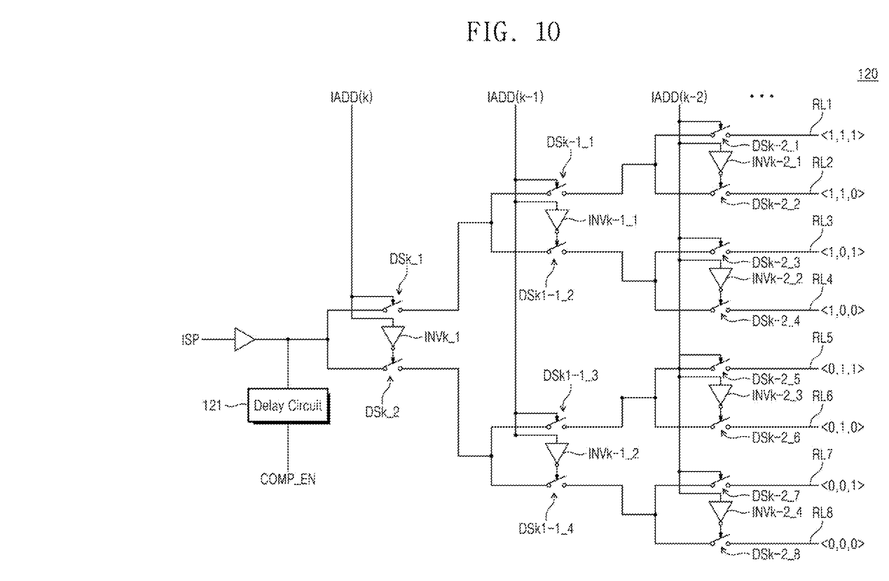

FIG. 10 is a diagram illustrating an example structure of an address decoder according to an embodiment of the present disclosure.

Referring to FIG. 10, an address decoder 120 may include a plurality of decoding switches (DSk1_1, DSk-2_1, DSk-2_2, …) and a plurality of inverters (INVk_1, INVk-1_1, INVk-1_2, …).

The address decoder 120 may receive an input address IADD including k bits. A k-th input address bit IADD(k) may be a most significant bit (MSB).

A decoding switch DSk_1 may be turned on by the k-th input address bit IADD(k). An inverter INVk_1 may invert the k-th input address bit IADD(k) and output the inverted result. Accordingly, a decoding switch DSk_2 may operate in an opposite manner to the decoding switch DSk_1. For example, when the decoding switch DSk_1 is turned on, the decoding switch DSk_2 is turned off, and when the decoding switch DSk_1 is turned off, the decoding switch DSk_2 is turned on. In other words, a path through which the spike input ISP is output may be determined according to a value of the k-th input address bit IADD(k). Similarly, a path through which the spike input ISP is output may be determined according to a (k–1)-th input address bit IADD(k–1).

The address decoder 120 may determine a path to output the spike input according to the received input address bits. For example, assume that the spike neural network circuit includes eight rows. When each of the received input address bits has values of <1, 1, 0>, decoding switches DSk_1, DSk-1_1, DSk-1_3, DSk- 2_2, DSk-2_4, DSk-2_6, and DSk-2_8 may be turned on, and the input spike ISP may be output to a second row line RL2. When each of the received input address bits has values of <0, 1, 0>, the input spike ISP may be output to a sixth row line RL6.

The address decoder 120 may further include a delay circuit 121. The delay circuit 121 may delay the input spike signal ISP by a predetermined time and output the input spike signal ISP as a compare enable signal COMP_EN. The compare enable signal COMP_EN may be delivered to a neuron circuit 150. A plurality of neurons included in the neuron circuit 150 may perform a voltage comparison operation in response to the compare enable signal COMP_EN. At this time, the predetermined time may be set to correspond to a time during which an analog charge operation is performed in a membrane. The neuron circuit 150 may perform an operation of comparing a membrane voltage with a reference voltage only when the compare enable signal COMP_EN is at a first logic level.

The address decoder 120 may have a tree-structured configuration implemented with switches and inverters such that only one input spike signal is output at a time. This may prevent input spike signals from being output in multiple rows simultaneously.

According to embodiments of the present disclosure, the spike neural network circuit may minimize leakage current to a gate terminal of a current source. This may reduce errors occurring when synapses perform an analog charge operation. Further, by allowing a plurality of synapses to share a bias current source, a semiconductor design area may be reduced.

The foregoing description illustrates specific embodiments for carrying out the present disclosure. The present disclosure is not limited to the embodiments described above but also includes embodiments that can be simply designed or readily modified. In addition, the present disclosure encompasses technologies that can be easily implemented in variations using the embodiments. Therefore, the scope of the present disclosure should not be construed as being limited to the foregoing embodiments, but should be defined by the claims that follow and their equivalents.

What is claimed is:

1. A spike neural network circuit comprising:
a first synapse connected to a first column line among a plurality of column lines and configured to adjust a charge level of the first column line according to a first synapse weight value in response to a first input spike signal applied to a first row line among a plurality of row lines;
a second synapse connected to the first column line and configured to adjust the charge level of the first column line according to a second synapse weight value in response to a second input spike signal applied to a second row line among the plurality of row lines;
a first shared bias current source configured to provide a bias current used when each of the first synapse and the second synapse adjusts the charge level of the first column line; and
a first neuron configured to compare a voltage level of the first column line with a reference voltage and to generate a first output spike signal in response to the voltage level of the first column line reaching the reference voltage.

2. The spike neural network circuit of claim 1, further comprising a first membrane capacitor configured to store the charge of the first column line.

3. The spike neural network circuit of claim 1, wherein each of the first synapse and the second synapse comprises:
a weight switch including a plurality of switches, wherein the weight switches are operating based on synapse weight bits, and a plurality of current branches respectively corresponding to the plurality of switches; and
an axon switch connecting a transmission line of the first column line to the weight switch and configured to operate in response to a corresponding input spike signal.

4. The spike neural network circuit of claim 3, wherein the first shared bias current source operates based on a bias voltage and comprises a plurality of current source transistors respectively corresponding to the plurality of current branches.

5. The spike neural network circuit of claim 4, wherein each of the plurality of current source transistors has a different current supply capability.

6. The spike neural network circuit of claim 5, wherein each of the plurality of current source transistors has a current supply capability increasing in powers of two.

7. The spike neural network circuit of claim 1, further comprising:
a third synapse connected to the first column line and configured to adjust the charge level of the first column line according to a third synapse weight value in response to a third input spike signal applied to a third row line among the plurality of row lines;
a fourth synapse connected to the first column line and configured to adjust the charge level of the first column line according to a fourth synapse weight value in response to a fourth input spike signal applied to a fourth row line among the plurality of row lines; and
a second shared bias current source configured to provide a bias current used when each of the third synapse and the fourth synapse adjusts the charge level of the first column line.

8. The spike neural network circuit of claim 1, further comprising:
a third synapse connected to a second column line among the plurality of column lines and configured to subtract a charge of the second column line according to a third synapse weight value in response to the first input spike signal;
a fourth synapse connected to the second column line and configured to subtract the charge of the second column line according to a fourth synapse weight value in response to the second input spike signal;
a second shared bias current source configured to provide a bias current used when each of the third synapse and the fourth synapse adjusts the charge level of the second column line; and
a second neuron configured to compare a voltage level of the second column line with a reference voltage and to generate a second output spike signal in response to the voltage level of the second column line reaching the reference voltage.

9. The spike neural network circuit of claim 1, further comprising an address decoder configured to receive an input address and a spike input in a pulse form, and to output an input spike signal to a row corresponding to the input address among the plurality of row lines in response to the spike input.

10. The spike neural network circuit of claim 1, further comprising an address encoder configured to generate an output address of a column line among the plurality of column lines from which the output spike signal is generated and to generate a spike output in a pulse form in response to the output spike signal.

11. A spike neural network circuit comprising:
a synapse circuit including a plurality of row lines, a plurality of column lines, and a plurality of synapses connected to the plurality of row lines and the plurality of column lines;
a neuron circuit including neurons configured to compare a voltage level of a corresponding one of the plurality of column lines with a reference voltage and to generate an output spike signal in response to the voltage level of the corresponding column line reaching the reference voltage;
an address decoder configured to receive an input address and a spike input in a pulse form, and to output an input spike signal to a row line corresponding to the input address among the plurality of row lines in response to the spike input; and
an address encoder configured to output an output address corresponding to a column line among the plurality of column lines from which the output spike signal is generated and to output a spike output in a pulse form in response to the output signal,
wherein the synapse circuit further includes a shared bias current source configured to provide a bias current used when each of a first synapse corresponding to a first column line and a second synapse corresponding to the first column line adjust the charge level of the first column line.

12. The spike neural network circuit of claim 11,
wherein the first synapse comprises a first weight switch connected to the shared bias current source and a first axon switch configured to connect the first weight switch to the first column line and to operate in response to an input spike signal applied to a first row line, and
wherein the second synapse comprises a second weight switch connected to the shared bias current source and a second axon switch configured to connect the second weight switch to the first column line and to operate in response to an input spike signal applied to a second row line.

13. The spike neural network circuit of claim 12, wherein each of the first weight switch and the second weight switch comprises a plurality of switches corresponding to respective ones of a plurality of synapse weight bits, and a plurality of current branches extending from the plurality of switches.

14. The spike neural network circuit of claim 13, wherein the shared bias current source comprises a plurality of current source transistors corresponding to the plurality of current branches.

15. The spike neural network circuit of claim 14, wherein each of the plurality of current source transistors has a current supply capability increasing in powers of two.
